(19) United States
(12) Patent Application Publication
(10) Pub. No.: US 2005/0239531 A1
(43) Pub. Date: Oct. 27, 2005

(54) Gaming machine

(75) Inventor: Akira Osawa, Tokyo (JP)

Correspondence Address: ARENT FOX PLLC, 1050 CONNECTICUT AVENUE, N.W., SUITE 400, WASHINGTON, DC, 20036, US

(73) Assignee: Aruze Corp.

(21) Appl. No.: 11/106,491

(22) Filed: Apr. 15, 2005

(30) Foreign Application Priority Data
Apr. 21, 2004 (JP) 2004-124885

(51) Int. Cl. A63F 13/00

(52) U.S. Cl. 463/16; 463/17

(57) ABSTRACT

In a gaming machine of the present invention, a bet must be placed as a prerequisite for starting a bonus game (second game). More specifically, a condition for switching from a normal game to a bonus game is that any one of a SPIN (SPIN/REPEAT BET) button 12, which is pushed to start a game at the current number of bets or previous number of bets, a 1-BET button 11, which is pushed to start a game with one bet, a 3-BET button 13, which is pushed to start a game with three bets, and a 5-BET button 14, which is pushed to start a game with five bets, be operated when a bonus game is currently established.

### RELATED APPLICATIONS

This application claims the priority of Japanese Patent Application No. 2004-124885 filed on Apr. 21, 2004, which is incorporated herein by reference.

### BACKGROUND OF THE INVENTION

1. Field of the Invention

The present invention relates to a gaming machine which executes a game in a bonus mode following a basic mode when a predetermined lottery result is obtained in a lottery to be reflected in the content of the game.

2. Description of the Prior Art

In a conventional gaming machine such as a slot machine, for example, a winning condition is determined by a combination of symbols displayed on an active pay line following the insertion of a coin. Examples of the winning condition include a so-called “big win” in which 1000 coins or more are paid out, a so-called “small win” in which less than 1000 coins are paid out, a so-called “second game win” in which a second game serving as a sub-game may be played, and so on (see Japanese Unexamined Patent Publication No. HEI 11-244453 (page 2 in particular), for example).

To describe the “second game win”, when a “second game win” is obtained in a first game, a second game can be played following the first game without inserting another coin. The second game is played by different rules to the first game, and is generally known as a bonus game. In the first game, for example, by operating a start lever or the like after placing a bet (wagering a coin), a sequence is initiated whereby each reel begins to rotate simultaneously and the rotation of each reel is stopped automatically. This sequence is executed only once. On the other hand, when a free game is played as the bonus game, the reels are rotated and stopped automatically without placing a bet, and the reels continue to be rotated and stopped automatically until a predetermined condition is satisfied.

Accordingly, when the bonus game continues for a long time with no bets placed, the coin payout may become large such that heavy losses are incurred on the arcade side. The bonus game in particular is often much more advantageous to a typical player than the first game, and hence heavy losses tend to be incurred on the arcade side.

### SUMMARY OF THE INVENTION

The present invention has been designed in consideration of these points, and it is an object thereof to provide a gaming machine in which a bet is required to begin a bonus game.

The present invention, which has been designed to achieve this object, is a gaming machine (for example, a slot machine 1) having first betting means (for example, a SPIN (SPIN/REPEAT BET) button 12, a 1-BET button 11, a 3-BET button 13, and a 5-BET button 14) for placing a bet on a game, lottery means (for example, a random number generator 55 and a random number sampling circuit 56) for performing a lottery to be reflected in the content of the game when a bet is placed through the first betting means (for example, the SPIN (SPIN/REPEAT BET) button 12, 1-BET button 11, 3-BET button 13, and 5-BET button 14), and game control means (for example, a CPU 50) for executing a basic mode of the game, and executing a bonus mode following the basic mode when a predetermined lottery result is obtained by the lottery means (for example, the random number generator 55 and random number sampling circuit 56). The gaming machine (for example, the slot machine 1) comprises second betting means (for example, the SPIN (SPIN/REPEAT BET) button 12, 1-BET button 11, 3-BET button 13, and 5-BET button 14) for placing a bet in the bonus mode such that when the predetermined lottery result is obtained by the lottery means (for example, the random number generator 55 and random number sampling circuit 56), the game control means (for example, the CPU 50) execute the bonus mode following the basic mode after a bet is placed through the second betting means (for example, the SPIN (SPIN/REPEAT BET) button 12, 1-BET button 11, 3-BET button 13, and 5-BET button 14).

Further, the gaming machine (for example, the slot machine 1) according to the invention described above preferably comprises display means (for example, an upper liquid crystal display 3) for displaying a message indicating that the bonus mode starts when the predetermined lottery result is obtained by the lottery means (for example, the random number generator 55 and random number sampling circuit 56).

Further, in the gaming machine (for example, the slot machine 1) according to the invention described above, the game control means (for example, the CPU 50) preferably continue the bonus mode until a predetermined condition is satisfied in the bonus mode.

In the gaming machine (for example, the slot machine 1) according to the invention described above, the predetermined condition is preferably a winning combination other than “no win”.

Further, in the gaming machine (for example, the slot machine 1) according to the invention described above, the game control means (for example, the CPU 50) preferably re-execute the bonus mode when a bet is placed through the second betting means (for example, the SPIN (SPIN/REPEAT BET) button 12, 1-BET button 11, 3-BET button 13, and 5-BET button 14).

In the gaming machine (for example, the slot machine 1) according to the invention described above, the second betting means (for example, the SPIN (SPIN/REPEAT BET) button 12, 1-BET button 11, 3-BET button 13, and 5-BET button 14) preferably comprises a pressable switch, and a betting operation is preferably performed by pushing the second betting means.

Further, in the gaming machine (for example, the slot machine 1) according to the invention described above, the bonus mode may be terminated on the condition that a predetermined award is paid out, or on the condition that a game in the bonus mode is repeated a predetermined number of times.

### BRIEF DESCRIPTION OF THE DRAWINGS

FIG. 1 is a perspective view of a slot machine;

FIG. 2 is a longitudinal sectional view of a lower liquid crystal display and a reel;

FIG. 3 is an exploded perspective view of the lower liquid crystal display;

FIG. 4 is a block diagram showing an outline of a control system of the slot machine;

FIG. 5 is a block diagram showing an outline of a liquid crystal drive circuit of the lower liquid crystal display;

FIG. 6 is an illustrative view showing an outline of symbol columns displayed variably on display windows, these symbol columns being displayed on the lower liquid crystal display during a normal game;

FIG. 7 is an illustrative view showing an outline of symbol columns displayed variably on the display windows, these symbol columns being displayed on reels that can be seen through the lower liquid crystal display during a bonus game;

FIGS. 8A, 8B and 8C are illustrative views showing lottery tables of stop display symbols when a normal game is played using three display windows;

FIG. 9 is an illustrative view showing winning combinations and the awards thereof when a normal game is played using the three display windows;

FIGS. 10A, 10B and 10C are illustrative views showing lottery tables of stop display symbols when a bonus game is played via the three display windows;

FIG. 11 is an illustrative view showing winning combinations and the awards thereof when a bonus game is played via the three display windows;

FIG. 12 is a flowchart of a main processing program;

FIG. 13 is a flowchart of a start reception processing program;

FIG. 14 is a flowchart of a lottery processing program;

FIG. 15 is a flowchart of a normal game processing program;

FIG. 16 is a flowchart of a bonus game processing program;

FIG. 17 is an illustrative view showing a lottery table of winning combinations and the awards thereof when a normal game is played using the three display windows; and

FIG. 18 is an illustrative view showing a lottery table of winning combinations and the awards thereof when a bonus game is played via the three display windows.

### DESCRIPTION OF THE PREFERRED EMBODIMENTS

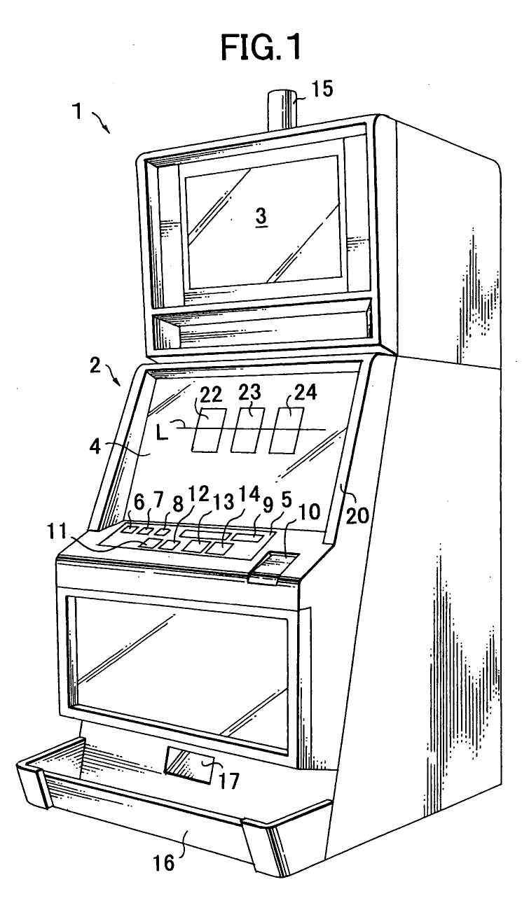

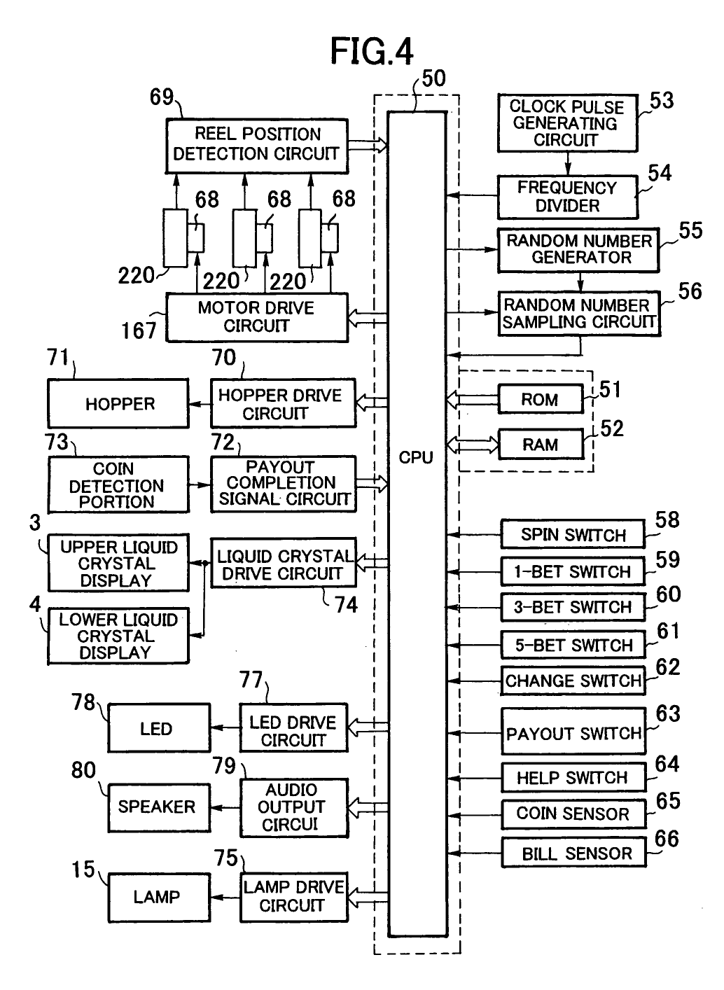

A gaming machine according to the present invention will now be described in detail on the basis of an embodiment of the present invention as a slot machine, with reference to the drawings. First, the schematic constitution of the slot machine pertaining to this embodiment will be described on the basis of FIGS. 1 and 4. FIG. 1 is a perspective view of the slot machine, and FIG. 4 is a block diagram showing an outline of a control system of the slot machine.

In FIG. 1, a slot machine 1 comprises a cabinet 2 which constitutes the slot machine 1 in its entirety, and a lamp 15 which is disposed on top of the upper surface of the cabinet 2. An upper liquid crystal display 3 is disposed in the upper portion of the front surface of the cabinet 2, and a lower liquid crystal display 4 is disposed in the center of the front surface of the cabinet 2. Here, the upper liquid crystal display 3 is constituted by a typical, general-use liquid crystal display, whereas the lower liquid crystal display 4 is constituted by a so-called transparent liquid crystal display. The upper liquid crystal display 3 displays information relating to the game such as the game playing method, winning combination types and awards, and various effects and the like relating to the game. As shown in FIG. 1, three display windows 22, 23, and 24 are displayed basically on the lower liquid crystal display 4, and various symbols to be described below are displayed variably on the respective display windows 22 to 24 while scrolling in a downward direction. Note that the constitution of the lower liquid crystal display 4 will be described in detail hereafter.

A control panel 5 which protrudes forward is provided below the lower liquid crystal display 4. This control panel 5 is provided from left to right with a CHANGE button 6, a PAYOUT button 7, and a HELP button 8. A coin insertion slot 9 and a bill insertion slot 10 are provided to the right of the HELP button 8. Further, a 1-BET button 11, a SPIN/REPEAT BET button 12, a 3-BET button 13, and a 5-BET button 14 are disposed from left to right on the front side of the control panel 5.

Here, the CHANGE button 6 serves to illuminate the lamp 15. A CHANGE switch 62 is annexed to the CHANGE button 6 such that when the CHANGE button 6 is pushed, a switch signal is output from the CHANGE switch 62 to a CPU 50.

The PAYOUT button 7 is pushed at the end of a normal game. When the PAYOUT button 7 is pushed, the coins gained during a game are paid out into a coin tray 16 from a coin payout opening 17. Note that a PAYOUT switch 63 is annexed to the PAYOUT button 7 such that when the PAYOUT button 7 is pushed, a switch signal is output to the CPU 50.

The HELP button 8 is pushed when the game playing method and so on are unclear. When the HELP button 8 is pushed, various help information is displayed on the upper liquid crystal display 3 and lower liquid crystal display 4. A HELP switch 64 is annexed to the help button 8 such that when the HELP button 8 is pushed, a switch signal is output to the CPU 50 from the HELP switch 64.

A coin sensor 65 is disposed in the coin insertion slot 9 such that when a coin is inserted into the coin insertion slot 9, a coin detection signal is output to the CPU 50 via the coin sensor 65. Further, a bill sensor 66 is disposed in the bill insertion slot 10 such that when a bill is inserted into the bill insertion slot 10, a bill detection signal is output to the CPU 50 via the bill sensor 66.

Every time the 1-BET button 11 is pushed, a single bet is placed. A 1-BET switch 59 is annexed to the 1-BET button 11 such that when the 1-BET button 11 is pushed, a switch signal is output to the CPU 50 from the 1-BET switch 59 on the basis of the pushing operation.

The SPIN (SPIN/REPEAT BET) button 12 is pushed to begin the variable display of various symbols on the display windows 22 to 24 of the lower liquid crystal display 4 in order to start a game at the current number of bets or the previous number of bets. A SPIN switch 58 is annexed to the SPIN button 12 such that when the SPIN button 12 is pushed, a switch signal is output to the CPU 50 from the SPIN switch 58 on the basis of the pushing operation. Note that 1, 2, 3, or 5 bets may be used as the number of bets that can be placed upon pushing operation of the SPIN button 12.

The 3-BET button 13 is pushed to start a game with three bets. A 3-BET switch 60 is annexed to the 3-BET button 13 such that when the 3-BET button 13 is pushed, a switch signal is output to the CPU 50 from the 3-BET switch 60. The 5-BET button 14 is pushed to start a game with five bets. A 5-BET switch 61 is annexed to the 5-BET button 14 such that when the 5-BET button 14 is pushed, a switch signal is output to the CPU 50 from the 5-BET switch 61.

Further, the coin payout opening 17 is formed in the lower portion of the cabinet 2, and the coin tray 16 is provided for receiving coins paid out from the coin payout opening 17. A coin detection portion 73 to be described below, constituted by a sensor or the like, is disposed in the interior of the coin payout opening 17. The coin detection portion 73 detects the number of coins paid out from the coin payout opening 17.

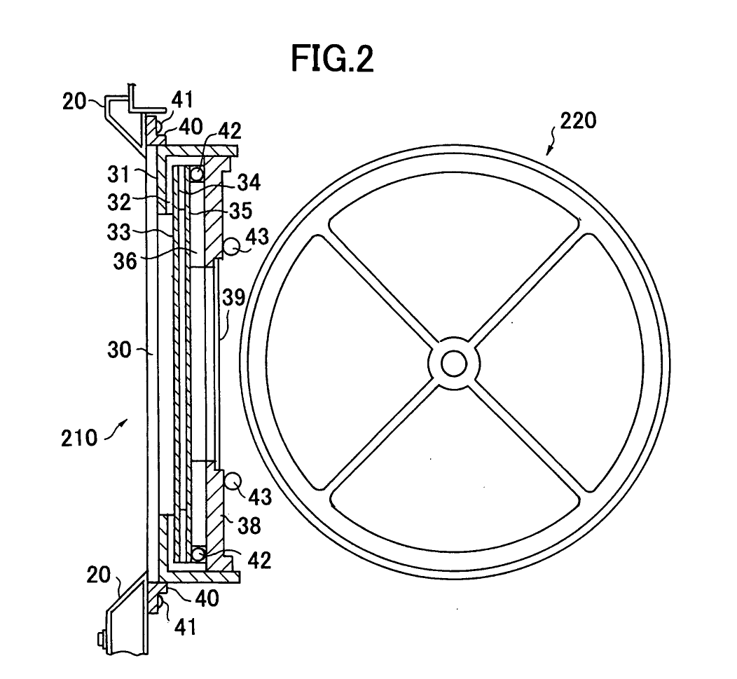

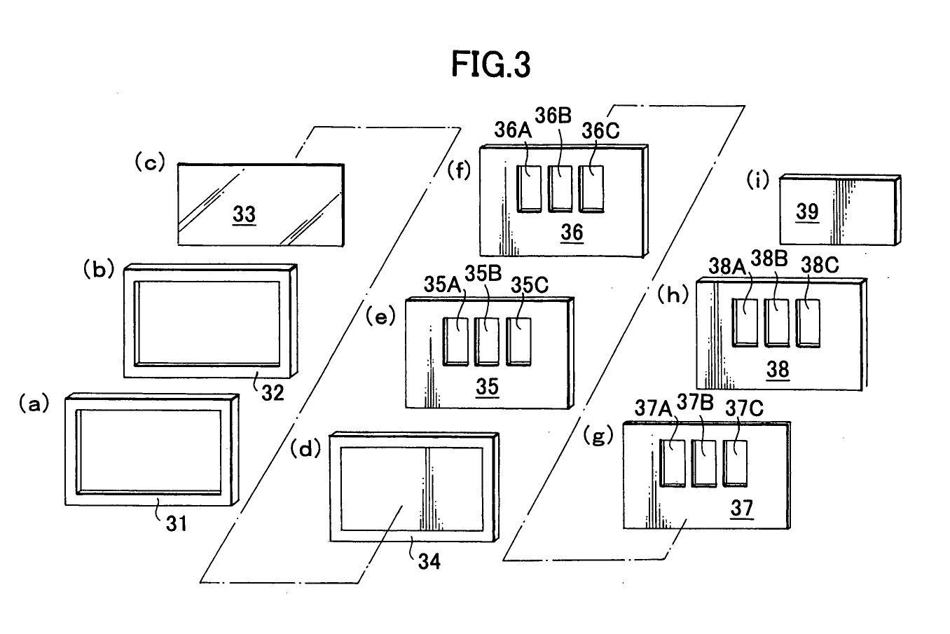

Next, the detailed constitution of the lower liquid crystal display 4 and a reel provided rotatably in the interior of the cabinet 2 on the rear surface side of the lower liquid crystal display 4 will be described on the basis of FIGS. 2 and 3. FIG. 2 is a longitudinal sectional view of the lower liquid crystal display and reel, and FIG. 3 is an exploded perspective view of the lower liquid crystal display.

In FIGS. 2 and 3, the lower liquid crystal display 4 is disposed on the inside of a display window portion 210 of a machine front surface panel 20, which is provided centrally in the front surface of the cabinet 2 of the slot machine 1, together with a transparent touch panel 30 disposed on the front surface side (the left side in FIG. 2) of the lower liquid crystal display 4. Three reels 220 (only one reel 220 is illustrated in FIG. 2) are supported in series on the rear surface side (the right side in FIG. 2) of the lower liquid crystal display 4 so as to be capable of independent rotation.

In other words, as shown in FIG. 2, the lower liquid crystal display 4 is disposed on the front surface side of the three reels 220. A normal game to be described hereafter is played on the lower liquid crystal display 4, and a bonus game to be described hereafter is played on the reels 220.

Note that in this embodiment, a normal game situation corresponds to a “basic mode”, and a bonus game situation corresponds to a “bonus mode”.

To describe the reels 220, the reel 220 of the three reels 220 which is on the left side when seen from the front surface of the slot machine 1 faces the display window 22 (see FIG. 1) formed on the lower liquid crystal display 4, the center reel 220 faces the display window 23 (see FIG. 1) formed similarly on the lower liquid crystal display 4, and the right side reel 220 faces the display window 24 (see FIG. 1) formed similarly on the lower liquid crystal display 4.

Note that the constitution of the display windows 22 to 24 will be described hereafter.

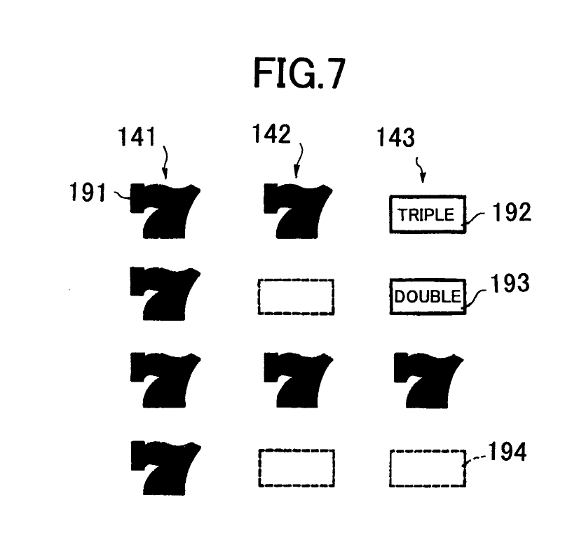

Various (three types in FIG. 7) symbols such as those shown in FIG. 7 are formed on the peripheral surface of each reel 220 for use in the bonus game to be described below. More specifically, a seven symbol 191, a triple symbol 192, and a double symbol 193 are used as the types of symbols formed on the peripheral surface of each reel 220. These three types of symbols and a blank (a region in which no symbol exists) 194 are combined on the peripheral surface of each reel 220 in predetermined combinations to form a total of twelve symbols and blanks.

Note that various winning combinations are preset on the basis of a plurality of symbol combination types, and when a symbol combination corresponding to a winning combination stops on an active pay line L (see FIG. 1), coins are paid out from the coin payout opening 17 in accordance with the winning combination. This point is similar to a conventional slot machine, and therefore further description is omitted here. Further, a typical method of forming the various symbols on the peripheral surface of the reels 220 involves printing four symbols on an elongated reel sheet which matches the width and circumference of the reels 220, and adhering the reel sheet to the peripheral surface of the reels 220. However, it goes without saying that another method may be employed to form the symbols.

Next, the constitution of the lower liquid crystal display 4 will be described on the basis of FIGS. 2 and 3. In FIGS. 2 and 3, the lower liquid crystal display 4 is constituted by the transparent touch panel 30, a reel glass base 31, a bezel metallic frame 32, a liquid crystal panel 33, a liquid crystal holder 34, a diffusion sheet 35, a light-guiding plate 36, a white reflector 37, a rear holder 38, and an antistatic sheet 39, disposed in series from the front surface side of the slot machine 1. The diffusion sheet 35 is formed with opening portions 35A, 35B, 35C, and the light-guiding plate 36, reflector 37, and rear holder 38 are formed similarly with opening portions 36A, 36B, 36C, opening portions 37A, 37B, 37C, and opening portions 38A, 38B, 38C, respectively, matching the opening portions 35A to 35C. The opening portions 35A to 38A are superposed so as to match each other, and thereby form the display window 22 (see FIG. 1). The opening portions 35B to 38B form the display window 23 (see FIG. 1) similarly, and the opening portions 35C to 38C form the display window 24 (see FIG. 1) similarly.

Here, the opening portions 35A to 35C of the diffusion sheet 35 and the opening portions 36A to 36C of the light-guiding plate 36 constitute a transmission region for ensuring the visibility of the display windows 22 to 24.

To mount the lower liquid crystal display 4 on the display window portion 210 of the machine front surface panel 20, brackets 40 provided so as to protrude vertically from the reel glass base 31 are screwed to the rear surface of the machine front surface panel 20 using screws 41, as shown in FIG. 2.

A pair of cold cathode ray tubes 42 serving as the light source of the liquid crystal panel 33 is provided at the upper and lower ends of the light-guiding plate 36. Further, a pair of cold cathode ray tubes 43 for illuminating the symbols formed on the outer peripheral surface of the reels 220 is provided at the top and bottom of the rear surface side of each opening portion 38A to 38C of the rear holder 38.

The liquid crystal panel 33 is a transparent electric display panel disposed on the front surface of each reel 220 and constituted by an ITO or the like through which the reels can be seen. The rear surface side on the periphery of the display portion is held by the liquid crystal holder 34. The light-guiding plate 36 is constituted by a light-permeable resin panel, and is formed with a lens cut which guides light emitted from the cold cathode ray tubes 42 positioned on the sides thereof to the rear surface side of the liquid crystal panel 33. The diffusion sheet 35 is constituted by a light-permeable resin sheet, and serves to diffuse the light that is guided by the light-guiding plate 36 in order to even out the light that is irradiated onto the liquid crystal panel 33. The liquid crystal holder 34 holding the liquid crystal panel 33, the diffusion sheet 35, and the light-guiding plate 36 are integrated and inserted by the periphery into the bezel metallic frame 32. As a result of this insertion, the front surface side of the display portion of the liquid crystal panel 33 is held by the bezel metallic frame 32.

The integrated liquid crystal holder 34, diffusion sheet 35, and light-guiding plate 36 fitted into the bezel metallic frame 32 are then inserted by the periphery into the reel glass base 31 and held by the reel glass base 31 such that the display portion front surface of the liquid crystal panel 33 is in an open state. By mounting the reel glass base 31 on the machine front face panel 20 using the screws 41, the transparent touch panel 30 is pressed against the front face of the reel glass base 31 and thus superimposed on the display portion front surface of the liquid crystal panel 33.

The rear holder 38 is constituted by a white resin plate, and holds the bezel metallic frame 32 supported on the reel glass base 31, the liquid crystal holder 34 holding the liquid crystal panel 33, the diffusion sheet 35, and the light-guiding plate 36 on the reel glass base 31 from the rear. The rear holder 38 also functions as a reflection plate for reflecting to the liquid crystal panel 33 side the light that is emitted from the cold cathode ray tubes 42 to the light-guiding plate 36. The antistatic sheet 39 is a transparent sheet that is adhered to the rear surface of the rear holder 38 by double-sided tape, and covers the rear surface of the openings 38A to 38C formed in the rear holder 38.

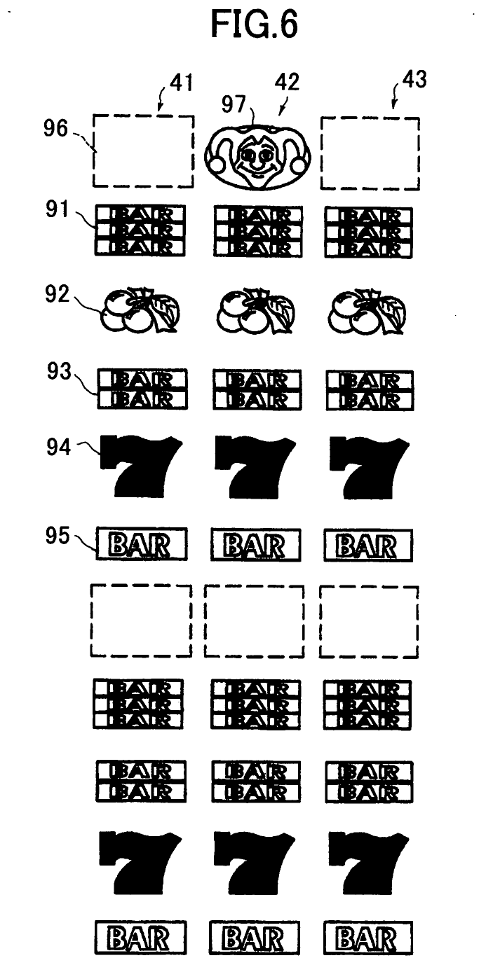

Next, on the basis of FIG. 6, examples of the symbol columns that are displayed variably while scrolling on the opaque display windows 22 to 24, and thereby displayed on the lower liquid crystal display 4 during a normal game, will be described. In FIG. 6, a symbol column 41 is displayed variably on the display window 22, a symbol column 42 is displayed variably on the display window 23, and a symbol column 43 is displayed variably on the display window 24.

Here, the symbol columns 41 and 43 have an identical symbol arrangement, and these symbol columns are constituted by eleven symbols comprising appropriate combinations of a triple BAR 91, a cherry 92, a double BAR 93, a seven 94, a single BAR 95, and a blank (a region in which no symbol exists) 96.

The symbol column 42 is similar to the symbol columns 41 and 43 in comprising a combination of the triple BAR 91, the cherry 92, the double BAR 93, the seven 94, the single BAR 95, and the blank 96, but also comprises a trigger symbol 97. This trigger symbol 97 is a symbol for advancing to the bonus game, as will be described hereafter, and hence when the trigger symbol 97 is stopped and displayed on the active pay line L of the display window 23, it is possible to advance to the bonus game.

Note that when the scrolling symbol columns 41 through 43 are stopped and displayed on the display windows 22 to 24, three symbols are stopped and displayed on each display window 22 to 24.

Furthermore, various winning combinations are preset on the basis of a plurality of symbol combination types, and when a symbol combination corresponding to a winning combination stops on the active pay line L, coins are paid out from the coin payout opening 17 in accordance with the winning combination. This point is similar to a conventional slot machine, and therefore further description is omitted here.

Next, the constitution of the control system of the slot machine 1 will be described on the basis of FIG. 4. FIG. 4 is a block diagram showing an outline of the control system of the slot machine.

In FIG. 4, the control system of the slot machine 1 is basically constituted using a CPU 50 as a core, with a ROM 51 and a RAM 52 connected to the CPU 50. The ROM 51 stores a main processing program, a normal game processing program, a bonus game processing program, a lottery table for drawing stop display symbols during a normal game, and a lottery table for drawing stop display symbols during a bonus game, all of which will be described below, as well as various other programs, data tables, and so on required to control the slot machine 1. The RAM 52 stores various data calculated by the CPU 50 (for example, whether a bonus game establishment flag to be described below is ON or OFF) temporarily.

The CPU 50 is also connected to a clock pulse generating circuit 53 for generating a reference clock pulse, a frequency divider 54, a random number generator 55 for generating random numbers, and a random number sampling circuit 56. Random numbers sampled via the random number sampling circuit 56 are used in various lotteries for drawing winning combinations and the like. The CPU 50 is also connected to the SPIN switch 58 annexed to the SPIN (SPIN/REPEAT BET) button 12, the 1-BET switch 59 annexed to the 1-BET button 11, the 3-BET switch 60 annexed to the 3-BET button 13, the 5-BET switch 61 annexed to the 5-BET button 14, the CHANGE switch 62 annexed to the CHANGE button 6, the PAYOUT switch 63 annexed to the PAYOUT button 7, and the HELP switch 64 annexed to the HELP button 8. The CPU 50 performs control to execute various operations corresponding to each button on the basis of the switch signals output from each switch when each button is pushed.

Three step motors 68 for rotating the reels 220 are connected to the CPU 50 via a motor drive circuit 167, and a reel position detection circuit 69 is also connected to the CPU 50. When a motor drive signal is output to the motor drive circuit 167 from the CPU 50, the step motors 68 are driven to rotate by the motor drive circuit 167. As a result, the reels 220 are rotated.

At this time, once the reels 220 have begun to rotate, the drive pulse count supplied to the respective step motors 68 is calculated, and the resulting calculation value is written into a predetermined area of the RAM 52. Further, a reset pulse is output from each reel 220 upon each revolution, and this reset pulse is input into the CPU 50 via the reel position detection circuit 69. When the reset pulse is input into the CPU 50 in this manner, the calculation value written into the RAM 52 is cleared to “0”, and the CPU 50 identifies the rotation position of the symbols on each reel 220 on the basis of the calculation value corresponding to the rotation position within the range of one revolution of each reel 220, and a symbol table stored in the ROM 51 which relates the rotation position of each reel 220 to the symbols formed on the peripheral surface of each reel 220.

The coin sensor 65 disposed in the coin insertion slot 9 and the bill sensor 66 disposed in the bill insertion slot 10 are also connected respectively to the CPU 50. The coin sensor 65 detects coins inserted through the coin insertion slot 9, and the CPU 50 calculates the number of inserted coins on the basis of a coin detection signal output from the coin sensor 65. The bill sensor 66 detects the type and value of bills inserted through the bill insertion slot 10, and the CPU 50 calculates the number of coins equivalent to the value of the bills on the basis of a bill detection signal output from the bill sensor 66.

A hopper 71 is connected to the CPU 50 via a hopper drive circuit 70. When a drive signal is output to the hopper drive circuit 70 from the CPU 50, the hopper 71 pays out a predetermined number of coins from the coin payout opening 17.

The coin detection portion 73 is also connected to the CPU 50 via a payout completion signal circuit 72. The coin detection portion 73 is disposed in the interior of the coin payout opening 17, and when it is detected that a predetermined number of coins has been paid out from the coin payout opening 17, a coin payout detection signal is output to the payout completion signal circuit 72 from the coin detection portion 73. On the basis of this coin payout detection signal, the payout completion signal circuit 72 outputs a payout completion signal to the CPU 50. The upper liquid crystal display 3 and lower liquid crystal display 4 are also connected to the CPU 50 via a liquid crystal drive circuit 74, whereby the upper liquid crystal display 3 and lower liquid crystal display 4 can be controlled by the CPU 50.

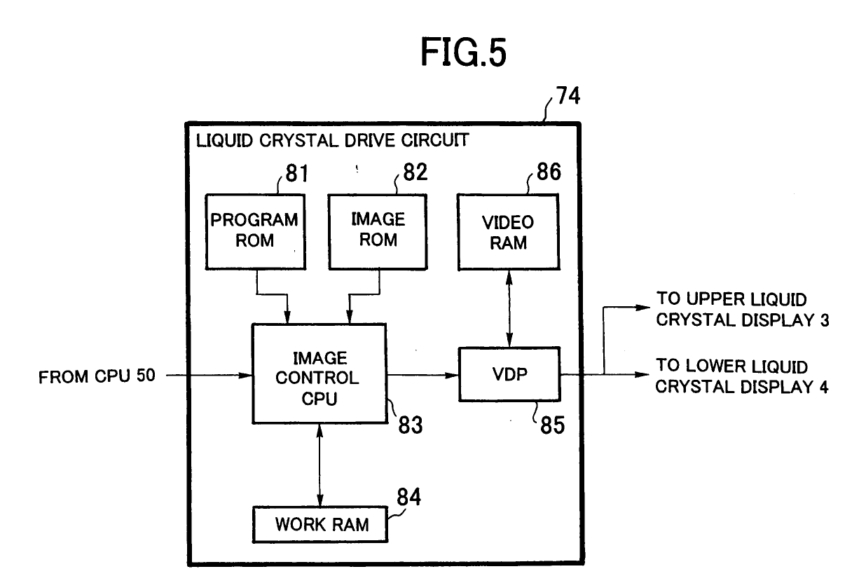

As shown in FIG. 5, the liquid crystal drive circuit 74 is constituted by a program ROM 81, an image ROM 82, an image control CPU 83, a work RAM 84, a VDP (video display processor) 85, a video RAM 86, and so on. The program ROM 81 stores an image control program and various selection tables relating to the display on the lower liquid crystal display 4. The image ROM 82 stores dot data for forming images, for example dot data for forming images on the upper liquid crystal display 3, the symbol columns 41 to 43 of FIG. 6, which are displayed on the lower liquid crystal display 4 (or the display windows 22 to 24), and so on. The image control CPU 83 determines images to be displayed on the upper liquid crystal display 3 and lower liquid crystal display 4 from among the dot data stored in advance in the image ROM 82 in accordance with an image control program stored in advance in the program ROM 81 and on the basis of parameters set by the CPU 50. The work RAM 84 serves as temporary storage means when the image control program is executed by the image control CPU 83. The VDP 85 forms images corresponding to the display content determined by the image control CPU 83, and outputs these images to the upper liquid crystal display 3 and lower liquid crystal display 4. As a result, the symbol columns 41 to 43 of FIG. 6 and so on, for example, are displayed as scrolls on the lower liquid crystal display 4 (or the display windows 22 to 24). The video RAM 86 serves as temporary storage means when images are formed by the VDP 85.

An LED 78 is also connected to the CPU 50 via an LED drive circuit 77. A large number of the LEDs 78 is provided on the front surface of the slot machine 1 such that when various effects are to be performed, the LEDs 78 are controlled to light up by the LED drive circuit 77 on the basis of a drive signal from the CPU 50. An audio output circuit 79 and a speaker 80 are also connected to the CPU 50. The speaker 80 generates various sound effects when various effects are performed on the basis of an output signal from the audio output circuit 79.

The lamp 15 is also connected to the CPU 50 via a lamp drive circuit 75. The lamp 15 is provided on the upper surface of the slot machine 1 (see FIG. 1) such that when the CHANGE button 6 is pushed, the lamp 15 is controlled to light up by the lamp drive circuit 75 on the basis of a drive signal from the CPU 50.

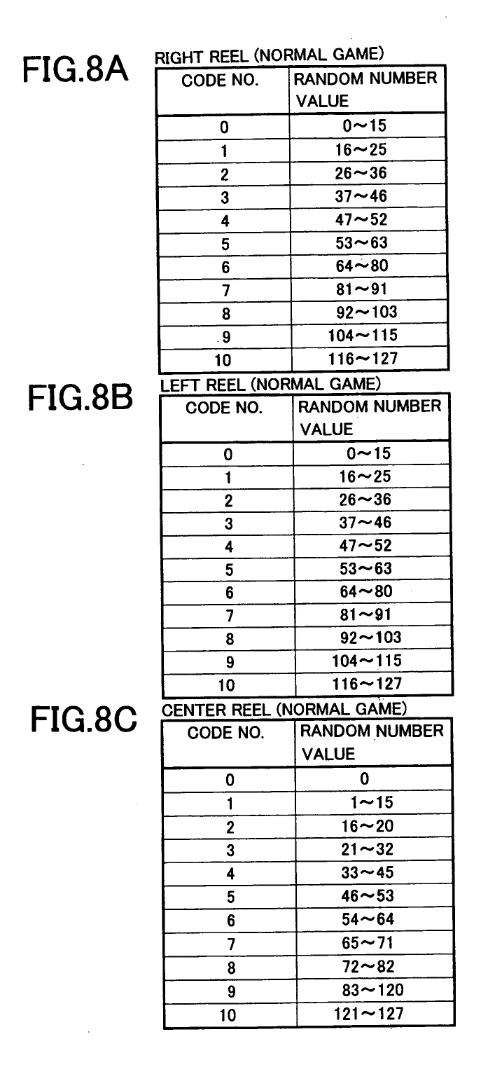

A lottery table used to determine the symbols to be stopped and displayed on the active pay line L when a normal game is played on the slot machine 1 using the three display windows 22 to 24 will now be described on the basis of FIGS. 8A through 8C. FIGS. 8A through 8C are illustrative views showing lottery tables of the stop display symbols when a normal game is played using the three display windows.

The symbols to be stopped and displayed on the active pay line L are determined for each display window 22 to 24. For this purpose, code numbers from “0” to “10” are allocated in sequence from top to bottom to each of the symbol columns 41 to 43 of the display windows 22 to 24 shown in FIG. 6, and lottery tables such as those shown in FIGS. 8A through 8C are prepared. Then, three random number values are sampled via the random number sampling circuit 56 to correspond to each of the display windows 22 to 24.

Note that in FIGS. 8A through 8C, for ease of description, the symbol column 41 of the right side display window 22 is described as the “right reel”, the symbol column 43 of the left side display window 24 is described as the “left reel”, and the symbol column 42 of the center display window 23 is described as the “center reel”.

To describe the “right reel” having the symbol column 41 of the right side display window 22: when the random number value sampled at this time through the random number sampling circuit 56 is within a range of 0 to 15, the blank 96 allocated to the code number “0” is stopped and displayed on the active pay line L; when the random number value is within a range of 16 to 25, the triple BAR 91 allocated to the code number “1” is stopped and displayed on the active pay line L; when the random number value is within a range of 26 to 36, the cherry 92 allocated to the code number “2” is stopped and displayed on the active pay line L; when the random number value is within a range of 37 to 46, the double BAR 93 allocated to the code number “3” is stopped and displayed on the active pay line L; when the random number value is within a range of 47 to 52, the seven 94 allocated to the code number “4” is stopped and displayed on the active pay line L; and when the random number value is within a range of 53 to 63, the single BAR 95 allocated to the code number “5” is stopped and displayed on the active pay line L. Further: when the random number value is within a range of 64 to 80, the blank 96 allocated to the code number “6” is stopped and displayed on the active pay line L; when the random number value is within a range of 81 to 91, the triple BAR 91 allocated to the code number “7” is stopped and displayed on the active pay line L; when the random number value is within a range of 92 to 103, the double BAR 93 allocated to the code number “8” is stopped and displayed on the active pay line L; when the random number value is within a range of 104 to 115, the seven 94 allocated to the code number “9” is stopped and displayed on the active pay line L; and when the random number value is within a range of 116 to 127, the single BAR 95 allocated to the code number “10” is stopped and displayed on the active pay line L.

To describe the “left reel” having the symbol column 43 of the left side display window 24, similarly to the “right reel” described above: when the random number value sampled at this time through the random number sampling circuit 56 is within a range of 0 to 15, the blank 96 allocated to the code number “0” is stopped and displayed on the active pay line L; when the random number value is within a range of 16 to 25, the triple BAR 91 allocated to the code number “1” is stopped and displayed on the active pay line L; when the random number value is within a range of 26 to 36, the cherry 92 allocated to the code number “2” is stopped and displayed on the active pay line L; when the random number value is within a range of 37 to 46, the double BAR 93 allocated to the code number “3” is stopped and displayed on the active pay line L; when the random number value is within a range of 47 to 52, the seven 94 allocated to the code number “4” is stopped and displayed on the active pay line L; and when the random number value is within a range of 53 to 63, the single BAR 95 allocated to the code number “5” is stopped and displayed on the active pay line L. Further: when the random number value is within a range of 64 to 80, the blank 96 allocated to the code number “6” is stopped and displayed on the active pay line L; when the random number value is within a range of 81 to 91, the triple BAR 91 allocated to the code number “7” is stopped and displayed on the active pay line L; when the random number value is within a range of 92 to 103, the double BAR 93 allocated to the code number “8” is stopped and displayed on the active pay line L; when the random number value is within a range of 104 to 115, the seven 94 allocated to the code number “9” is stopped and displayed on the active pay line L; and when the random number value is within a range of 116 to 127, the single BAR 95 allocated to the code number “10” is stopped and displayed on the active pay line L.

Meanwhile, to describe the “center reel” having the symbol column 42 of the center display window 22: when the random number value sampled at this time through the random number sampling circuit 56 is 0, the trigger symbol 97 allocated to the code number “0” is stopped and displayed on the active pay line L; when the random number value is within a range of 1 to 15, the triple BAR 91 allocated to the code number “1” is stopped and displayed on the active pay line L; when the random number value is within a range of 16 to 20, the cherry 92 allocated to the code number “2” is stopped and displayed on the active pay line L; when the random number value is within a range of 21 to 32, the double BAR 93 allocated to the code number “3” is stopped and displayed on the active pay line L; when the random number value is within a range of 33 to 45, the seven 94 allocated to the code number “4” is stopped and displayed on the active pay line L; and when the random number value is within a range of 46 to 53, the single BAR 95 allocated to the code number “5” is stopped and displayed on the active pay line L. Further: when the random number value is within a range of 54 to 64, the blank 96 allocated to the code number “6” is stopped and displayed on the active pay line L; when the random number value is within a range of 65 to 71, the triple BAR 91 allocated to the code number “7” is stopped and displayed on the active pay line L; when the random number value is within a range of 72 to 82, the double BAR 93 allocated to the code number “8” is stopped and displayed on the active pay line L; when the random number value is within a range of 83 to 120, the seven 94 allocated to the code number “9” is stopped and displayed on the active pay line L; and when the random number value is within a range of 121 to 127, the single BAR 95 allocated to the code number “10” is stopped and displayed on the active pay line L.

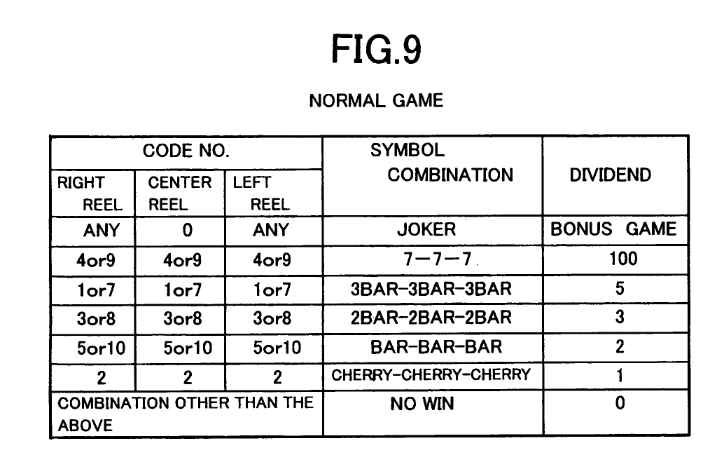

Next, winning combinations and their awards during a normal game played on the slot machine 1 using the three display windows 22 to 24 will be described on the basis of FIG. 9. FIG. 9 is an illustrative view showing winning combinations and their awards when a normal game is played using the three display windows 22 to 24. In FIG. 9, when the code number of the “center reel” is “0”, a bonus game is awarded even if the code number of the “right reel” and “left reel” is any of the code number “0” to “10”. In this case, the trigger symbol 97 is stopped and displayed on the active pay line L of the display window 23, an award of “500” is received, and the bonus game may be played. Here, the bonus game is performed after the normal game, and is often advantageous to a player. In this case, a condition for advancing to the bonus game is that coins or the like be wagered, and hence a game which corresponds to the bet (once only, for example) is played. If the player is able to win coins or the like at this time, the bonus game ends, but if the player is not able to win coins or the like, the bonus game state is maintained such that if coins or the like are bet again, a game corresponding to the bet (once only, for example) can be played. Note that in the bonus game, the awards corresponding to the various winning combinations are typically set higher, and hence the player often wins a large amount of coins or the like.

When the code number of all of the “right reel”, “center reel”, and “left reel” is “4” or “9”, “7-7-7” is drawn. In this case, the seven 94 is stopped and displayed on the active pay line L of each display window 22 to 24, and an award of “100” is received. If the code number of all of the “right reel”, “center reel”, and “left reel” is “1” or “7”, “3BAR-3BAR-3BAR” is drawn. In this case, the 3BAR 91 is stopped and displayed on the active pay line L of each display window 22 to 24, and an award of “5” is received. If the code number of all of the “right reel”, “center reel”, and “left reel” is “3” or “8”, “2BAR-2BAR-2BAR” is drawn. In this case, the 2BAR 93 is stopped and displayed on the active pay line L of each display window 22 to 24, and an award of “3” is received. If the code number of all of the “right reel”, “center reel”, and “left reel” is “5” or “10”, “1BAR-1BAR-1BAR” is drawn. In this case, the 1BAR 95 is stopped and displayed on the active pay line L of each display window 22 to 24, and an award of “2” is received. If the code number of all of the “right reel”, “center reel”, and “left reel” is “2”, “cherry-cherry-cherry” is drawn. In this case, the cherry 92 is stopped and displayed on the active pay line L of each display window 22 to 24, and an award of “1” is received.

When the code numbers of “right reel”, “center reel”, and “left reel” are in any other combination, “no win” is drawn. In this case, one of the triple BAR 91, cherry 92, double BAR 93, seven 94, single BAR 95, and blank 96, corresponding to each code number, is stopped and displayed on the active pay line L of each of the display windows 22 to 24, and no award is paid out.

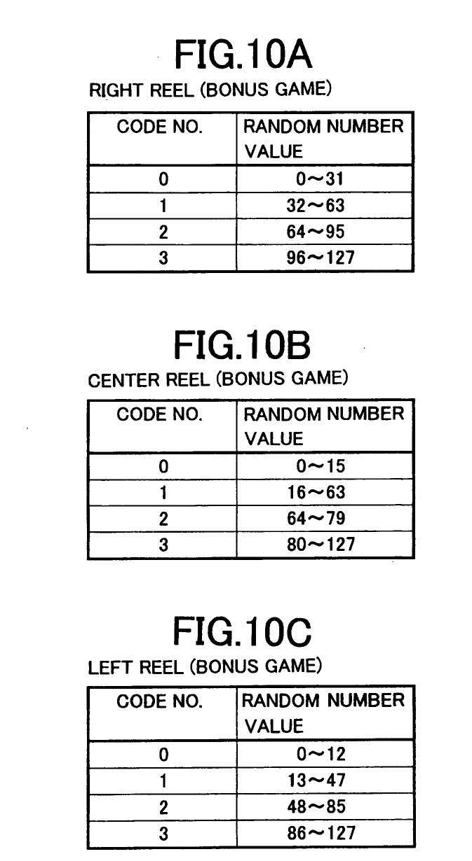

Next, a lottery table used to determine the symbols to be stopped and displayed on the active pay line L when a bonus game is played on the slot machine 1 will be described on the basis of FIGS. 10A through 10C. Note that the bonus game is played via the three display windows 22 to 24, through which the symbols adhered to the three reels 220 can be seen. FIGS. 10A through 10C are illustrative views showing lottery tables of stop display symbols when a bonus game is played via the three display windows.

The symbols to be stopped and displayed on the active pay line L are determined for each of the three reels 220. For this purpose, code numbers from “0” to “3” are allocated in sequence from top to bottom to each of the symbol columns 141 to 143 of the three reels 220 shown in FIG. 7, and lottery tables such as those shown in FIGS. 10A through 10C are prepared. Then, three random number values are sampled via the random number sampling circuit 56 to correspond to each of the three reels 220.

Note that in FIGS. 10A through 10C, for convenience of description, the reel 220 formed with symbol column 141 that can be seen through the right side display window 22 is described as the “right reel”, the reel 220 formed with the symbol column 143 that can be seen through the left side display window 24 is described as the “left reel”, and the reel 220 formed with the symbol column 142 that can be seen through the center display window 23 is described as the “center reel”.

To describe the “right reel”, which is the reel 220 formed with the symbol column 141: when the random number value sampled at this time through the random number sampling circuit 56 is within a range of 0 to 31, the seven symbol 191 allocated to the code number “0” is stopped and displayed on the active pay line L; when the random number value is within a range of 32 to 63, the seven symbol 191 allocated to the code number “1” is stopped and displayed on the active pay line L; when the random number value is within a range of 64 to 95, the seven symbol 191 allocated to the code number “2” is stopped and displayed on the active pay line L; and when the random number value is within a range of 96 to 127, the seven symbol 191 allocated to the code number “3” is stopped and displayed on the active pay line L

To describe the “center reel” having the symbol column 142: when the random number value sampled at this time through the random number sampling circuit 56 is within a range of 0 to 15, the seven symbol 191 allocated to the code number “0” is stopped and displayed on the active pay line L; when the random number value is within a range of 16 to 63, the blank 194 allocated to the code number “1” is stopped and displayed on the active pay line L; when the random number value is within a range of 64 to 79, the seven symbol 191 allocated to the code number “2” is stopped and displayed on the active pay line L; and when the random number value is within a range of 80 to 127, the blank 194 allocated to the code number “3” is stopped and displayed on the active pay line L.

To describe the “left reel” having the symbol column 143: when the random number value sampled at this time through the random number sampling circuit 56 is within a range of 0 to 12, the triple symbol 192 allocated to the code number “0” is stopped and displayed on the active pay line L; when the random number value is within a range of 13 to 47, the double symbol 193 allocated to the code number “1” is stopped and displayed on the active pay line L; when the random number value is within a range of 48 to 85, the seven symbol 191 allocated to the code number “2” is stopped and displayed on the active pay line L; and when the random number value is within a range of 86 to 127, the blank 194 allocated to the code number “3” is stopped and displayed on the active pay line L.

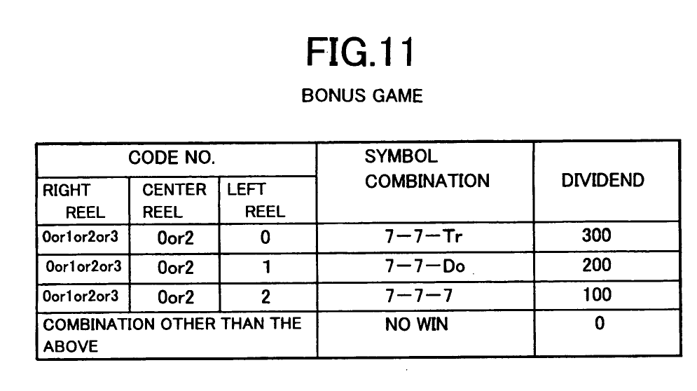

Next, winning combinations and their awards during a bonus game played on the slot machine 1 via the three display windows 22 to 24 will be described on the basis of FIG. 11. FIG. 11 is an illustrative view showing winning combinations and their awards when a bonus game is played via the three display windows. In FIG. 11, when the code number of the “right reel” is any number from “0” to “3”, the code number of the “center reel” is “0” or “2”, and the code number of the “left reel” is “0”, “7-7-Tr” is drawn. In this case, the seven symbol 191, the seven symbol 191, and the triple symbol 192 are stopped and displayed on the active pay line L via the display windows 22 to 24, and an award of “300” is received. When the code number of the “right reel” is any number from “0” to “3”, the code number of the “center reel” is “0” or “2”, and the code number of the “left reel” is “1”, “7-7-Do” is drawn. In this case, the seven symbol 191, the seven symbol 191, and the double symbol 193 are stopped and displayed on the active pay line L via the display windows 22 to 24, and an award of “200” is received. If the code number of the “right reel” is any number from “0” to “3”, the code number of the “center reel” is “0” or “2”, and the code number of the “left reel” is “2”, “7-7-7” is drawn. In this case, the seven symbol 191, the seven symbol 191, and the seven symbol 191 are stopped and displayed on the active pay line L via the display windows 22 to 24, and an award of “100” is received.

When the code numbers of “right reel”, “center reel”, and “left reel” are in any other combination, “no win” is drawn. In this case, one of the seven symbol 191, the triple symbol 192, the double symbol 193, and the blank 194, corresponding to each code number, is stopped and displayed on the active pay line L via each of the display windows 22 to 24, and no award is paid out

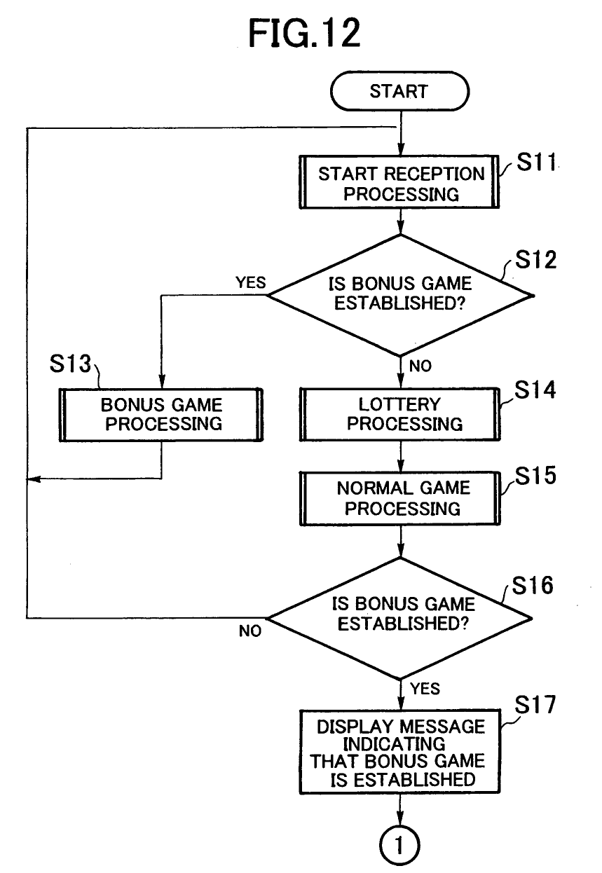

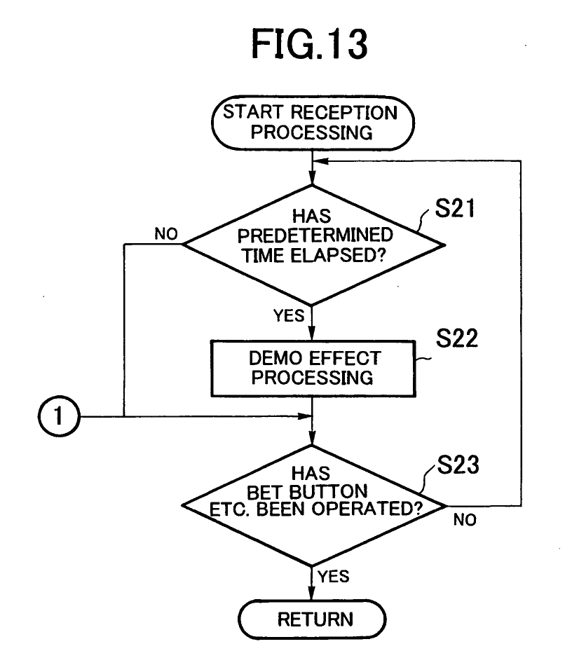

Next, a main processing program executed by the slot machine 1 will be described on the basis of FIG. 12. FIG. 12 is a flowchart of the main processing program. In FIG. 12, in an initial step (abbreviated to “S” hereafter) 11, start reception processing of FIG. 13, to be described below, is performed. In this processing, a switch signal output from the SPIN switch 58, 1-BET switch 59, 3-BET switch 60, or 5-BET switch 61 on the basis of an operation of the SPIN (SPIN/REPEAT BET) button 12, the 1-BET button 11, the 3-BET button 13, or the 5-BET button 14, is received. The game begins at the point where a switch signal output from one of the switches is received.

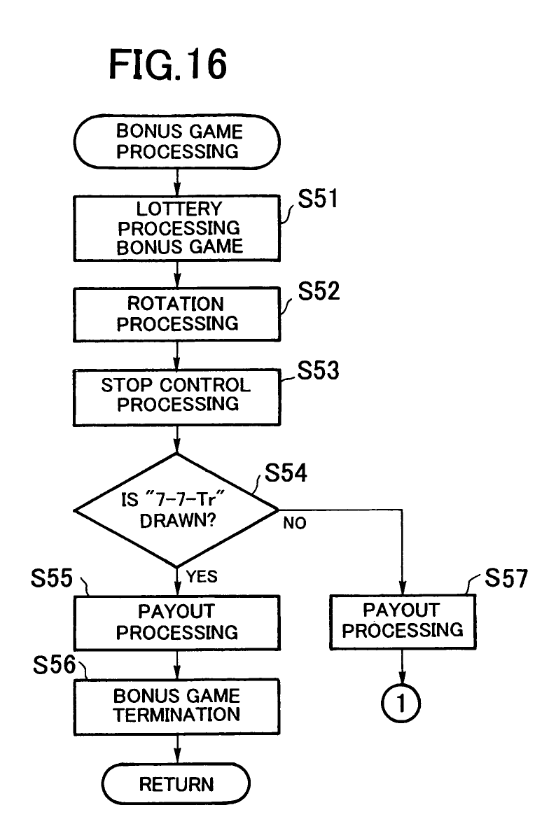

Next, in S12, a determination is made as to whether or not a bonus game is established. More specifically, when a bonus game establishment flag stored in the RAM 52 is ON, a bonus game is determined to be established, and when the bonus game establishment flag stored in the RAM 52 is OFF, it is determined that a bonus game is not established. When it is determined that a bonus game is established at this time (S12: YES), the routine advances to S13, where bonus game processing of FIG. 16, to be described below, is performed. The routine then returns to S11, where the processing described above is repeated. On the other hand, when it is determined that a bonus game is not established (S12: NO), the routine advances to S14.

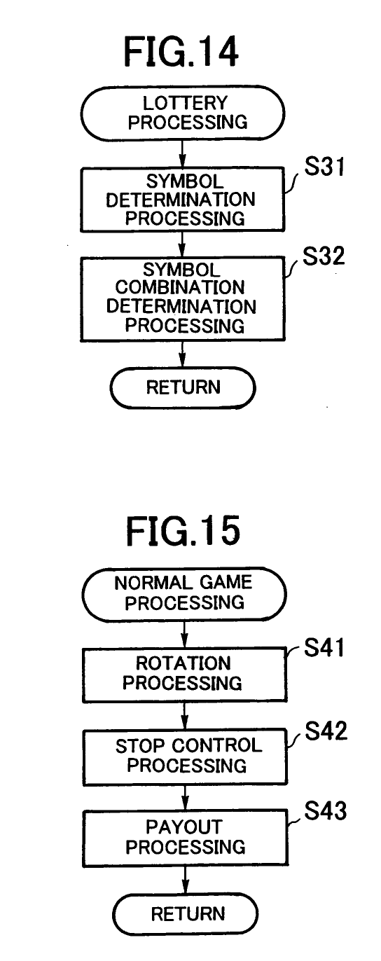

In S14, lottery processing of FIG. 14, to be described below, is performed on the basis of the aforementioned switch signal output from the SPIN switch 58, 1-BET switch 59, 3-BET switch 60, or 5-BET switch 61.

Next, in S15, normal game processing of FIG. 15, to be described below, is performed. The routine then advances to S16, where a determination is made as to whether or not a bonus game has been established. More specifically, when the random number value of the “center reel”, sampled via the random number sampling circuit 56 during the lottery processing in S14, is 0, a bonus game is awarded (S16: YES), and hence the routine advances to S17, where the bonus game establishment flag stored in the RAM 52 is set to ON, and a phrase such as “You won a bonus game!”, for example, is displayed on the upper liquid crystal display 3 to indicate that a bonus game has been established. The routine then advances to S23 of the start reception processing of FIG. 13, to be described below. If, on the other hand, the random number value of the “center reel”, sampled via the random number sampling circuit 56 during the lottery processing in S14, is between 1 and 127, a bonus game is not awarded (S16: NO), and hence the routine returns to S11, where the processing described above is repeated.

Next, a start reception processing program executed by the slot machine 1 will be described on the basis of FIG. 13. FIG. 13 is a flowchart of the start reception processing program. Start reception processing is performed in S11 of the main processing program of FIG. 12 described above, and for this purpose, first the routine advances to S21 in FIG. 13, where a determination is made as to whether or not a predetermined time period (15 seconds, for example) has elapsed. When it is determined that the predetermined time period has not elapsed (S21: NO), the routine advances to S23 as is, but when it is determined that the predetermined time period has elapsed (S21: YES), in S22 a demo effect is performed on the upper liquid crystal display 3 and lower liquid crystal display 4, after which the routine advances to S23. In S23, a determination is made as to whether or not any of the SPIN (SPIN/REPEAT BET) button 12, the 1-BET button 11, the 3-BET button 13, and the 5-BET button 14 has been operated. Here, if it is determined that the 1-BET button 11 and so on have not been operated (S23: NO), the routine returns to S21, where the processing described above is repeated. If, on the other hand, it is determined that the 1-BET button 11 or another button has been operated (S23: YES), the routine returns to the main processing program of FIG. 12, even if the aforementioned demo effect is underway, and advances to the determination processing of S12.

Next, a lottery processing program executed by the slot machine 1 will be described on the basis of FIG. 14. FIG. 14 is a flowchart of the lottery processing program. Lottery processing is performed in S14 of the main processing program of FIG. 12 described above, and for this purpose, first the routine advances to S31 in FIG. 14, where symbol determination processing is performed. During a normal game, the symbols to be stopped and displayed on the active pay line L are determined for each of the display windows 22 to 24. More specifically, as described above, three random numbers corresponding to each of the display windows 22 to 24 are sampled by the random number sampling circuit 56, and the stop display symbols are determined on the basis of the lottery tables in FIG. 8 using the code numbers. Once the symbols to be stopped and displayed on the active pay line L have been determined, symbol combination determination processing is performed in S32, whereupon the routine returns to the main processing program of FIG. 12 and advances to the normal game processing of S15. Note that in symbol combination determination processing, as described above, winning combinations and their awards are determined on the basis of the table shown in FIG. 9 using the code numbers of S31.

Next, a normal game processing program executed by the slot machine 1 will be described on the basis of FIG. 15. FIG. 15 is a flowchart of the normal game processing program. Normal game processing is performed in S15 of the main processing program of FIG. 12 described above, and for this purpose, first, in S41 of FIG. 15, the symbols on the display windows 22 to 24 are scrolled on the basis of the switch signal output from the SPIN switch 58, 1-BET switch 59, 3-BET switch 60, or 5-BET switch 61 and received in S11 of FIG. 12. Note that at this time, since the symbols displayed on the display windows 22 to 24 are scrolled, the symbols on the three reels 220 within the cabinet 2 cannot be seen through the display windows 22 to 24.

In S42, the symbols on the display windows 22 to 24 are halted.

In S43, coins or the like corresponding to the awards set in advance on the basis of the table in FIG. 9 are paid out in accordance with the combination of symbols of a winning combination displayed on the display windows 22 to 24 in S42. Following the processing of S43, the routine returns to the main processing program of FIG. 12, and advances to the determination processing of S16.

Next, a bonus game processing program executed by the slot machine 1 will be described on the basis of FIG. 16. FIG. 16 is a flowchart of the bonus game processing program. When it is determined that a bonus game is established in S12 of the main processing program in FIG. 12 (S12: YES), the routine advances to S13 of FIG. 12, where bonus game processing is performed. For this purpose, first the routine advances to S51 of FIG. 16, where bonus game lottery processing is performed. During a bonus game, the symbols to be stopped and displayed on the active pay line L are determined for each reel 220 via the display windows 22 to 24. More specifically, as described above, three random numbers corresponding to each reel 220 are sampled by the random number sampling circuit 56 upon advancement to S51, and the stop display symbols are determined on the basis of the lottery tables in FIG. 10 using the code numbers.

Next, in S52, the three reels 220 are rotated automatically, and in the following S53, the three reels 220 are halted automatically.

Next, in S54, symbol combination determination is performed. More specifically, as described above, winning combinations and their awards are determined on the basis of the table in FIG. 11 using the code numbers.

If “7-7-Tr” is drawn at this time (S54: YES), a number of coins corresponding to the winning combination “7-7-Tr” is paid out in S55. The routine then advances to S56, where the bonus game establishment flag stored in the RAM 52 is set to OFF, and the bonus game processing program is terminated. The routine then returns to S11 in the main processing program of FIG. 12.

If “7-7-Tr” is not drawn (S54: NO), the routine advances to S57, where a number of coins corresponding to the winning combination in this case is paid out. The routine then advances to S23 of the start reception processing in FIG. 13.

Note that in the determination processing of S54, the determination may be performed using a winning combination other than “7-7-Tr”.

Thus in the slot machine 1 of this embodiment, when the SPIN (SPIN/REPEAT BET) button 12, which is pushed to start a game at the current number of bets or previous number of bets, the 1-BET button 11, which is pushed to start a game with one bet, the 3-BET button 13, which is pushed to start a game with three bets, or the 5-BET button 14, which is pushed to start a game with five bets, is operated (S23: YES) during the start reception processing (S11), the lottery processing (S14) is performed on the condition that a bonus game is not currently established (S12: NO).

During the lottery processing (S14), three random number values corresponding to each of the display windows 22 to 24 are sampled via the random number sampling circuit 56. During the normal game processing (S15), the symbols allocated respectively to the sampled values are stopped and displayed on the active pay line L of the display windows 22 to 24, and an award is paid out in accordance with the combination of symbols displayed on the active pay line L. When a random number value of 0 is sampled by the random number sampling circuit 56 in relation to the “center reel” having the symbol column 42 of the center display window 23, the trigger symbol 97 allocated to the code number “0” is stopped and displayed on the active pay line L, and a bonus game is awarded (see FIG. 9).

Note, however, that the bonus game is not begun immediately. Instead, it is determined in the current lottery processing (S14) that a bonus game is established (S16: YES), whereby the routine returns to the start reception processing (S11) to wait for an operation of the SPIN (SPIN/REPEAT BET) button 12, 1-BET button 11, 3-BET button 13, or 5-BET button 14 (S23: NO).

Since a bonus game is currently established (S12: YES), the bonus game processing (S13) is performed when the SPIN (SPIN/REPEAT BET) button 12, 1-BET button 11, 3-BET button 13, or 5-BET button 14 is operated (S23: YES). Thus the bonus game is begun.

Hence in the slot machine 1 of this embodiment, a condition for beginning the bonus game is that when the bonus game is currently established (S12: YES), the SPIN (SPIN/REPEAT BET) button 12, which is pushed to start a game at the current number of bets or previous number of bets, the 1-BET button 11, which is pushed to start a game with one bet, the 3-BET button 13, which is pushed to start a game with three bets, or the 5-BET button 14, which is pushed to start a game with five bets, must be operated (S23: YES). Accordingly, a bet must be placed (coins must be wagered), and as a result, losses on the arcade side can be reduced.

Further, in the slot machine 1 of this embodiment, when it is determined that a bonus game is established (S16: YES) during the current lottery processing (S14), a phrase such as “You won a bonus game!”, for example, is displayed on the upper liquid crystal display 3 to indicate that a bonus game has been established (S17), thereby notifying the player that a bonus game has been established and starts by placing a bet (wagering coins).

Further, in the slot machine 1 of this embodiment, when a winning combination other than “no win” is drawn during the bonus game (S54: NO), the bonus game is terminated (S56). However, when “no win” is drawn (S54: YES), the routine returns to the start reception processing (S11) without terminating the bonus game, and waits for the SPIN (SPIN/REPEAT BET) button 12, 1-BET button 11, 3-BET button 13, or 5-BET button 14 to be operated (S23: NO). Since a bonus game is currently established (S12: YES), the bonus game processing (S13) is performed anew when the SPIN (SPIN/REPEAT BET) button 12, 1-BET button 11, 3-BET button 13, or 5-BET button 14 is operated (S23: YES), whereby the bonus game starts again.

Hence in the slot machine 1 of this embodiment, the bonus game continues until a winning combination other than “no win” is obtained, but for the duration of the bonus game, further bets must be placed (coins must be wagered) to re-execute the bonus game, and hence losses on the arcade side can be reduced even further.

Note that the present invention is not limited to the embodiment described above, and may be modified in various ways within a scope that does not depart from the spirit of the invention.

For example, in the slot machine 1 of this embodiment, the bonus game is based on so-called “special awards” in which the awards for the various winning combinations are set higher than those of a normal game. However, a so-called “jackpot”, in which awards are saved for each game played, may be employed instead. A constitution may also be employed whereby the content of the bonus game is identical to the content of the normal game but the awards of the bonus game are several times higher than those of the normal game.

Further, in the slot machine 1 of this embodiment, the bonus game is terminated on the condition that an award is won (S54: NO, S55, S56), but the bonus game may be terminated after being repeated a predetermined number of times.

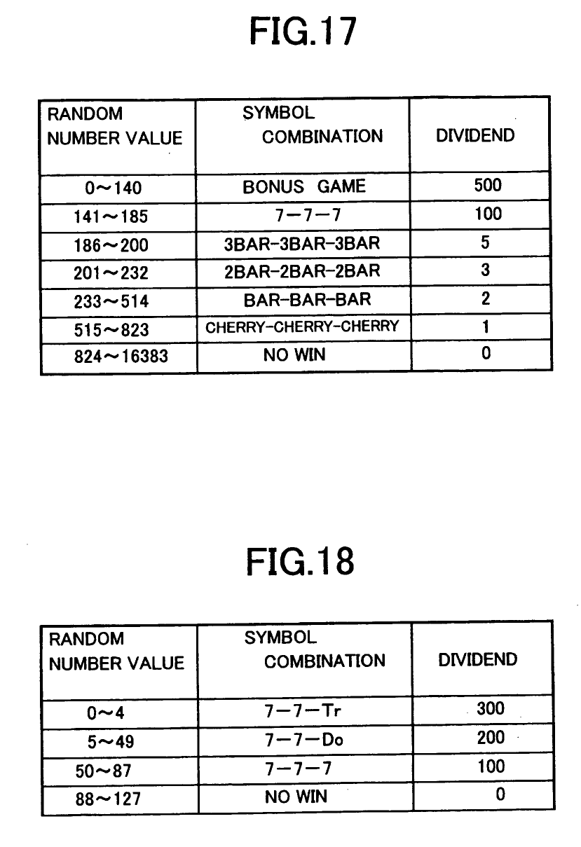

Also in the slot machine 1 of this embodiment, during a normal game, the symbols to be stopped and displayed on the active pay line L are determined for each of the display windows 22 to 24 using random numbers sampled by the random number sampling circuit 56 (see FIG. 8), but it is possible to determine all of the symbols to be stopped and displayed on the active pay line L of the display windows 22 to 24 using a random number sampled by the random number sampling circuit 56. For this purpose, a winning combination lottery table shown in FIG. 17 is used. FIG. 17 is an illustrative view showing a lottery table of winning combinations and their awards when a normal game is played using the three display windows.

In FIG. 17, the range of the random number used in the winning combination lottery table is 0 to 16383. When the random number sampled by the random number sampling circuit 56 is within a range of 0 to 140, a bonus game is awarded, and an award of “500” is paid out. In this case, the trigger symbol 97 is stopped and displayed on the active pay line L of the display window 23, and a bonus game may be played.

When the random number sampled by the random number sampling circuit 56 is within a range of 141 to 185, “7-7-7” is drawn, and an award of “100” is paid out. In this case, the seven 94 is stopped and displayed on the active pay line L of each of the display windows 22 to 24. Similarly, when the random number sampled by the random number sampling circuit 56 is within a range of 186 to 200, “3BAR-3BAR-3BAR” is drawn, and an award of “5” is paid out. In this case, the triple BAR 91 is stopped and displayed on the active pay line L of each of the display windows 22 to 24. Similarly, when the random number sampled by the random number sampling circuit 56 is within a range of 201 to 232, “2BAR-2BAR-2BAR” is drawn, and an award of “3” is paid out. In this case, the double BAR 93 is stopped and displayed on the active pay line L of each of the display windows 22 to 24. Similarly, when the random number sampled by the random number sampling circuit 56 is within a range of 233 to 514, “BAR-BAR-BAR” is drawn, and an award of “2” is paid out. In this case, the single BAR 95 is stopped and displayed on the active pay line L of each of the display windows 22 to 24. Similarly, when the random number sampled by the random number sampling circuit 56 is within a range of 515 to 823, “cherry-cherry-cherry” is drawn, and an award of “1” is paid out. In this case, the cherry 92 is stopped and displayed on the active pay line L of each of the display windows 22 to 24.

When the sampled random number is within a range of 824 to 16383, “no win” is drawn. In this case, a combination of symbols other than those described above is stopped and displayed on the active pay line L of each of the display windows 22 to 24, and no award is paid out.

Also in the slot machine 1 of this embodiment, during a bonus game the symbols to be stopped and displayed on the active pay line L via the display windows 22 to 24 are determined for each of the reels 220 using random numbers sampled by the random number sampling circuit 56 (see FIG. 10), but it is possible to determine all of the symbols to be stopped and displayed on the active pay line L via the display windows 22 to 24 using a random number sampled by the random number sampling circuit 56. For this purpose, a winning combination lottery table shown in FIG. 18 is used. FIG. 18 is an illustrative view showing a lottery table of winning combinations and their awards when a bonus game is played via the three display windows.

In FIG. 18, the range of the random number used in the winning combination lottery table is 0 to 127. When the random number sampled by the random number sampling circuit 56 is within a range of 0 to 4, “7-7-Tr” is drawn, and an award of “300” is paid out. In this case, the seven symbol 191, the seven symbol 191, and the triple symbol 192 are stopped and displayed on the active pay line L via the display windows 22 to 24. Similarly, when the sampled random number is within a range of 5 to 49, “7-7-Do” is drawn, and an award of “200” is paid out. In this case, the seven symbol 191, the seven symbol 191, and the double symbol 193 are stopped and displayed on the active pay line L via the display windows 22 to 24. Similarly, when the sampled random number is within a range of 50 to 87, “7-7-7” is drawn, and an award of “100” is paid out. In this case, the seven symbol 191, the seven symbol 191, and the seven symbol 191 are stopped and displayed on the active pay line L via the display windows 22 to 24.

When the sampled random number is within a range of 88 to 127, “no win” is drawn. In this case, a combination of symbols other than those described above is stopped and displayed on the active pay line L via the display windows 22 to 24, and no award is paid out.

Further, in the slot machine 1 of this embodiment, a bonus game is played as the “second game”. In the present invention, the “second game” may include free games that allow free spins of reels, known bonus games, and the like. In addition, the present invention may be applied to a gaming machine that provides a plurality of second games wherein at least one of the second games requires additional bet by the second betting means.

Further, in the slot machine 1 of this embodiment, games using symbols are played in the normal game and bonus game (see FIGS. 6, 7), but the present invention is not limited thereto, and games using cards, such as poker for example, may be played.

In the gaming machine of the present invention, a lottery to be reflected in the content of the game is performed when a bet is placed, and when a predetermined lottery result is obtained, a game in the bonus mode is executed following the basic mode. If no further bets are placed at this time, the basic mode cannot be switched to the bonus mode, and therefore a bet must be placed to start the bonus mode.

Hence in terms of betting, the basic mode and bonus mode are independent of each other, and therefore probability calculations (payout rate calculations) such as simulations can be performed.

1. A gaming machine comprising:
a first betting unit for placing a bet on a game;
a lottery unit for performing a lottery to be reflected in the content of said game when a bet is placed through said first betting unit; and
a game control device for executing a basic mode of said game and for executing a bonus mode following said basic mode when a predetermined lottery result is obtained by said lottery unit,
wherein said gaming machine comprises a second betting unit for placing a bet in said bonus mode, and
when said predetermined lottery result is obtained by said lottery unit, said game control device executes said bonus mode following said basic mode after a bet is placed through said second betting unit.

2. The gaming machine according to claim 1, comprising a display device for displaying a message indicating that said bonus mode starts when said predetermined lottery result is obtained by said lottery unit.

3. The gaming machine according to claim 1, wherein said game control device continues said bonus mode until a predetermined condition is satisfied in said bonus mode.

4. The gaming machine according to claim 3, wherein said predetermined condition is a winning combination other than “no win”.

5. The gaming machine according to claim 3, wherein said game control device re-executes said bonus mode when a bet is placed through said second betting unit.

6. The gaming machine according to claim 1, wherein said second betting unit comprises a pressable switch, and a betting operation is performed by pushing said switch.

7. The gaming machine according to claim 1, wherein said bonus mode is terminated on the condition that a predetermined award is paid out.

8. The gaming machine according to claim 1, wherein said bonus mode is terminated on the condition that a game in said bonus mode is repeated a predetermined number of times.

9. A gaming machine having first betting means for placing a bet on a game, lottery means for performing a lottery to be reflected in the content of said game when a bet is placed through said first betting means, and game control means for executing a basic mode of said game and for executing a bonus mode following said basic mode when a predetermined lottery result is obtained by said lottery means,
wherein said gaming machine comprises second betting means for placing a bet in said bonus mode, and
when said predetermined lottery result is obtained by said lottery means, said game control means execute said bonus mode following said basic mode after a bet is placed through said second betting means.
